(19) United States
(12) Patent Application Publication
(10) Pub. No.: US 2025/0041957 A1
(43) Pub. Date: Feb. 6, 2025

(54) TOOL-ELECTRODE CAPABLE OF PRODUCING SEALING SLOTS IN A CMC MATERIAL BY MEANS OF EDM

(71) Applicant: SAFRAN AIRCRAFT ENGINES, Paris (FR)

(72) Inventors: Janvier François LECOMTE, Moissy-Cramayel (FR); Aurélie BOESCH, Moissy-Cramayel (FR); Freddy Guy GUILBAUD, Moissy-Cramayel (FR)

(73) Assignee: SAFRAN AIRCRAFT ENGINES, Paris (FR)

(21) Appl. No.: 18/717,347

(22) PCT Filed: Nov. 28, 2022
(86) PCT No.: PCT/FR2022/052183

§ 371 Date: Jun. 6, 2024

(30) Foreign Application Priority Data
Dec. 8, 2021 (FR) 2113156

(51) Int. Cl. B23H 1/06; B23H 9/00

(52) U.S. Cl. CPC B23H 1/06; B23H 9/006

(57) ABSTRACT

A tool-electrode for machining an imprint in a conductive part by sinking-die type electrical-discharge machining. It includes a conductive body having lower and upper opposite surfaces, two opposite main lateral surfaces, lower and upper areas superposed according to a die-sinking direction of the tool-electrode, the lower area comprising the lower surface and a portion of the main lateral surfaces, the upper area including the upper surface and the other portion of the main lateral surfaces. The body is provided, at least in the lower area, with a plurality of openings selected from among channels or slots; a channel is an opening which opens onto at least one of the upper and lower surfaces; a slot is an opening which opens onto the lower surface and onto the two main lateral surfaces.

### TECHNICAL FIELD

The field of the invention is that of machining an imprint in an electrically-conductive material by the electrical-discharge machining (or EDM) technique, English acronym for “Electro Discharge Machining”). In particular, the invention relates to making, by EDM, sealing slots in high-pressure (HP) turbine rings for aircraft, made of a ceramic matrix composite (CMC) material.

### PRIOR ART

In the context of the production of the first HP rings made of SiC/SiC type CMC material, a study has been conducted in order to determine whether it was possible to make sealing slots in these CMC rings by machining using the electrical-discharge machining technique.

These SiC/SiC rings are made from a fibrous reinforcement in the form of three-dimensional woven pieces from SiC fibers (silicon carbide) sheathed with BN (boron nitride). Afterwards, the reinforcement is densified so that the fibers are buried in a matrix predominantly made of SiC. The densification is obtained through several successive steps and the SiC/SiC material thus obtained has specific physicochemical properties such as its high hardness, which make it difficult to machine with a cutting tool.

In addition, the shapes and the widths of the sealing slots of less than 1 mm require using tools with small dimensions to machine them, which also substantially reduces the machinability rate.

Finally, conventionally, the sealing slots are made by EDM for metallic aeronautical parts.

For all these reasons, it has been decided to make the slots of the CMC rings by the EDM technique, after having checked beforehand that the material was sufficiently electrically-conductive.

As a reminder and as illustrated in FIG. 1, electrical-discharge machining or EDM has the general principle of removing material by thermal erosion generated by a succession of electrical discharges between a tool-electrode 1 and the part to be machined 2, both being immersed in an electrically-insulating machining liquid, so-called dielectric 4. The part to be machined should necessarily be electrically-conductive (a conductivity higher than 10-2 S/cm) and is generally connected to the negative pole of a current source, whereas the tool-electrode is connected to the positive pole of the current source.

In the context of the present invention, die-sinking type electrical-discharge machining is considered, wherein a tool-electrode 1 with a shape complementary to the shape to be machined sinks into the part to be machined. Thus, the inverse shape of the tool is reproduced in the part and forms what is called the imprint 3 (FIG. 1).

The dielectric is intended to reduce the temperature of the machining area, this area could sometimes reach a temperature between 8,000° C. and 12,000° C., evacuate the residual particles (slags) produced during the electrical-discharge machining and enable the creation of the spark.

The application of a voltage generates an electric field between the tool-electrode and the part. The breakdown voltage is the minimum electrical voltage that renders a portion of an electrical insulator electrically-conductive and which enables the ignition of the spark in the dielectric; this breakdown voltage depends on:
the priming voltage;
the pulse time;
the peak current (setpoint maximum current);
the distance between the part to be made and the tool-electrode (this distance being referred to as “gap” or “machining gap”);
the insulating power of the dielectric;
the dielectric watering conditions.

Tests have been conducted by the Inventors on samples in order to find the best technique for machining sealing slots on a turbine ring made of SiC/SiC.

The targeted dimensional and geometric requirements for the sealing slots are as follows:
a depth of 2 to 5 mm;
a width of 0.5 to 1 mm;
a maximum radius of 0.3 mm for outer fillets (for example at the edges);
a maximum radius of 0.3 mm on all inner filets (at the bottom of the sealing slots).

Moreover, the target surface condition requirement is a roughness (Ra) lower than or equal to 5 μm.

First, the Inventors have used the technologies and strategies commonly used on metal materials for EDM machining of sealing slots on the SiC/SiC CMC composite material. Hence, they have used, as tool-electrodes, blades machined out of solid material, graphite or copper alloy.

Because of the low electrical conductivity of the CMC SiC/SiC composite material (comprised between 0.1 and 1 S·cm⁻¹), the electrodes made of copper alloys have proved to be more suitable for EDM machining of this material, because they have a better conductivity than graphites.

The first electrodes used are electrodes made of Cu-a1 type copper (AFNOR standard (or Cu-ETP (ISO standard)) with a 0.5 mm thickness for a target sealing slot width of 0.8 mm.

The machining strategy used consists in performing two descends of the tool-electrode (blank and finish) in the part immersed in a hydrocarbon dielectric, the second descent taking place after resharpening the tip of the tool-electrode in order to clear off any wear and best approach the geometric requirements.

For the blank mode, a vertical die-sinking according to the Z axis is carried out up to the depth-programmed side. On the other hand, for the finish mode, a planetary movement in the X and Y directions with an eccentricity radius (also called eccentricity vector) of about 0.15 mm is carried out to best approach the geometric dimensions of the sealing slots with 0.8 mm desired width.

Moreover, the Inventors have chosen to machine the first samples with low-energy parameters.

Following these first machining tests, several lessons have been learned:
the material removal rate (in mm³/min) is significantly lower on the CMC material than on a metal material (ratio<1/3);
an exponential decrease in the speed of advance of machining is observed as sinking in the solid material progresses;
despite the low-energy modes used in finishing to obtain the target roughness (Ra), the roughness measured on the surfaces of the sidewalls of the sealing slots are between 10 and 12 μm; this obtained roughness is essentially related to the blank mode (direct die-sinking) with a machining gap of about 0.15 mm and therefore, with a 0.5 mm thick tool-electrode, the 0.8 mm side is already reached in the blank and, consequently, the machined surfaces are barely recovered with the planetary movement of the tool-electrode in the finish mode;
sparking during the blank mode is not constant (i.e. stable and repeatable); indeed, arc sparks are detected which cause fractures in the SiC/SiC ceramic and generate large particles of material, difficult to evacuate with regards to the machining gap; cracks are also observed at the surface and sub-surface, cracking, as well as the formation of sparse craters over the machined surfaces;
the performances are very closely related to the renewal of the dielectric and to the evacuation of the eroded particles and of the produced gases; indeed, the material torn off the electrodes is in the form of small spherules, whose dimensions range from a few micrometers in the finish mode to a few hundred micrometers in the blank mode; these particles accumulate in the machining gap and rapidly end up by creating conductive bridges between the tool-electrode and the part to be machined; these phenomena have already been noticed for metal material machining, but they are amplified when machining “refractory” ceramics with the EDM process; indeed, the removal of material resulting from the thermal erosion of the “refractory” ceramics is generated essentially by fracturing and very little by the meltdown of the material, thereby the formation of larger debris to be evacuated; this is why the circulation of the dielectric between the tool-electrode and the part is essential for EDM machining of CMC materials;
the number and the size of the observed surface irregularities are also related to the heterogeneous material and to the variations in porosities present during making thereof.

In view of these observations, the Inventors have sought to design a tool-electrode able to be used to machine a CMC material by EDM erosion, in particular for producing sealing slots in a SiC/SiC material, while substantially increasing the performance of the current EDM process and improving the obtained surface conditions.

### Disclosure of the Invention

For this purpose, an object of the invention is a tool-electrode for machining, in a part made of an electrically-conductive material, an imprint by sinking-die type electrical-discharge machining, the tool-electrode including a body made of an electrically-conductive material having a lower face and an upper face, opposite to each other, and two main lateral faces, opposite to each other, the body having a lower area and an upper area, which are superimposed according to a die-sinking direction of the tool-electrode, the lower area comprising the lower face and a portion of the main lateral faces and the upper area comprising the upper face and the other portion of the main lateral faces,
the tool-electrode being characterized in that the body is provided, at least in the lower area, with a plurality of openings selected from among channels or slots,
a channel being an opening that opens onto at least one amongst the upper and lower faces,
a slot being an opening that opens onto the lower face and onto the two main lateral faces,
each channel having a diameter smaller than or equal to twice the die-sinking machining gap, and
each slot having a width, defined by a distance between two lateral walls of the slot, smaller than or equal to twice the die-sinking machining gap, and a height, in the die-sinking direction, larger than or equal to three times the depth of the imprint to be made.

For example, the die-sinking machining gap is comprised between 0.02 mm and 0.3 mm.

According to a first variant, the tool-electrode includes channels in the lower area and these channels extend in the upper area, each channel opening onto both the lower face and the upper face of the body.

Advantageously, in this first variant, the distance between two adjacent channels is larger than or equal to twice the die-sinking machining gap.

According to a second variant, the tool-electrode includes openings only in the lower area, these openings being slots. In this second variant, the upper area is therefore free of openings.

Advantageously, in this second variant, the distance between two adjacent slots is larger than or equal to twice the die-sinking machining gap.

According to a third variant, the tool-electrode includes slots in the lower area and channels in the upper area, each channel of the upper area opening onto a slot of the lower area. In other words, each channel is superposed on a slot according to the die-sinking direction. The combination of the channels and slots allows for a better distribution of the dielectric the closest to the sparking in order to obtain a better stability of machining and optimize the evacuation of the slags and therefore gain in performance.

Advantageously, the body of the tool-electrode is made of a CuCrZr copper alloy, preferably of CuCr₁Zr_{0.1}

Advantageously, the height of the lower area according to the die-sinking direction is at least twice as large as the height of the upper area according to the die-sinking direction.

Preferably, the imprint to be machined having to have given depth, length, and width, the body of the electrode has a thickness that is smaller than a value corresponding to the width of the imprint, from which the die-sinking machining gap is subtracted twice (i.e. e<I−(2×G)).

The invention also relates to a machining device for machining an imprint by die-sinking type electrical-discharge machining, the device comprising an tool-electrode as described hereinabove and means cooperating with the openings of the tool-electrode to create a machining liquid circulation in the bottom of the imprint being formed, these means being selected from among means for injecting pressurized machining liquid into the plurality of openings of the tool-electrode, when the openings are channels, and means for injecting machining liquid around the electrode, when the openings are slots.

The invention also relates to a method for forming an imprint in a part made of an electrically-conductive material by electrical-discharge machining, implementing a machining device according to claim 9, and comprising the steps of:
immersing the part in a machining liquid;
forming a blank of the imprint, by die-sinking the tool-electrode according to the die-sinking direction and concomitant injection of machining liquid into the plurality of openings of the tool-electrode to create a machining liquid circulation in the bottom of the blank;
finishing the imprint by placing the tool-electrode at the center of the blank and off-centering (also so-called flattening) the tool-electrode in a plane perpendicular to the die-sinking direction, wherein the eccentricity radius is larger than or equal to the die-sinking machining gap.

It should be recalled that, in a known manner, the method includes a blank machining, followed by a finishing machining. In the context of the invention, in the blank mode, the machining gap may be comprised between 0.10 mm and 0.3 mm; in the finish mode, the machining gap may be comprised between 0.02 mm and 0.10 mm.

Preferably, the step of injecting machining liquid into the plurality of openings of the tool-electrode is concomitant with the step of finishing the imprint and with the step of finishing the imprint.

Advantageously, the imprint to be machined is a sealing slot and the part is made of a SiC/SiC composite material. Preferably, the imprint to be machined is a sealing slot for a turbine ring.

### BRIEF DESCRIPTION OF THE DRAWINGS

Other advantages and features of the invention will appear more clearly upon reading the following detailed description of preferred embodiments thereof, given as a non-limiting example, and made with reference to the appended drawings, wherein:

FIG. 1 is a schematic illustration in section and in a front view showing the general principle of die-sinking type electrical-discharge machining according to the Z axis;

FIG. 2 is a schematic illustration according to a perspective front view of the tool-electrode according to a first embodiment of the invention;

FIG. 3 is a sectional view according to the plane A of the tool-electrode of FIG. 2, the tool-electrode being shown in the imprint of the part to be machined;

FIG. 4 is a schematic illustration in section and according to a top view showing the eccentricity of the tool-electrode of FIG. 3 in the imprint according to the X-Y plane;

FIG. 5 is a sectional view according to a front view of the tool-electrode of FIG. 3, the tool-electrode being shown in the imprint of the part and showing the circulation of the machining liquid;

FIG. 6a is a schematic illustration according to a front view of the tool-electrode according to a second embodiment of the invention;

FIG. 6b is a sectional view according to the line B-B of the tool-electrode of FIG. 6a;

FIG. 7a is a schematic illustration according to a front view of the tool-electrode according to a third embodiment of the invention;

FIG. 7b is a sectional view according to the line C-C of the tool-electrode of FIG. 7a.

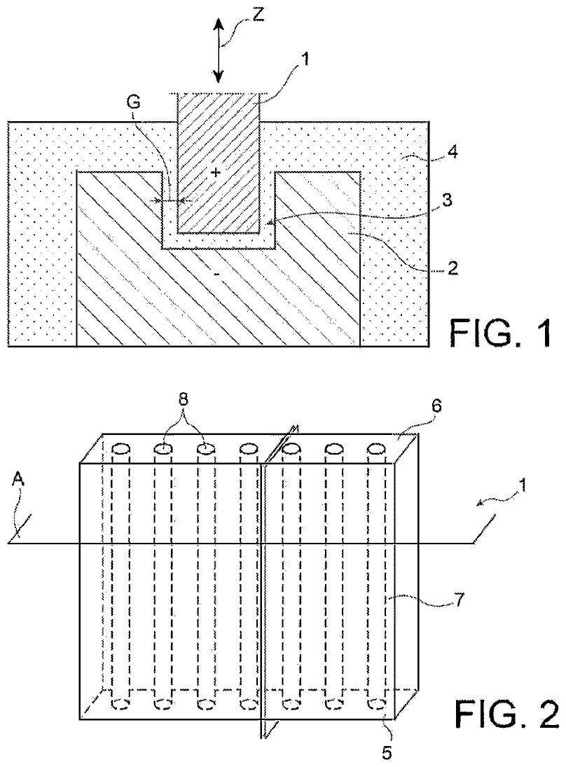

It is specified that the different elements are not plotted to scale.

### DETAILED DISCLOSURE OF PARTICULAR EMBODIMENTS

In the case of a tool-electrode of the prior art, despite the immersion of the part to be machined in the dielectric and an external watering around the tool-electrode, the material debris located at the bottom of the machining cavity cannot be evacuated and considerably affect the progress of the machining depending on the machined depth. The tool-electrode according to the invention allows improving the distribution of the dielectric in the machining cavity.

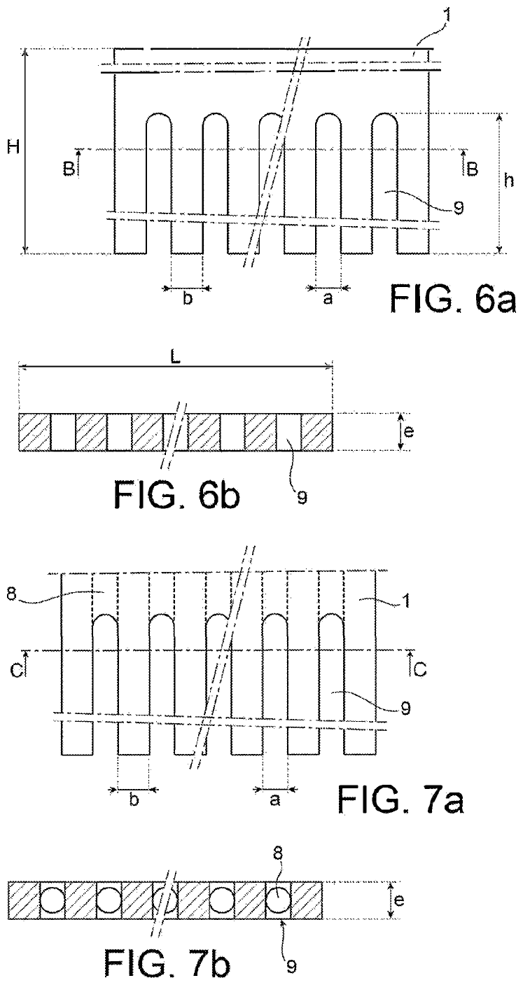

FIGS. 2 to 7b show preferred embodiments of tool-electrodes according to the invention, namely a configuration with through-channels (FIG. 2), a comb-like shaped configuration (FIG. 6a) and a configuration comprising both through-channels in the top portion and a comb-like shape in the bottom portion (FIG. 7a).

The plurality of openings in the tool-electrode according to the invention, whether these are channels 8, slots 9 or a combination of both, allows creating a forced circulation of machining liquid in the machining gap G, which results, on the one hand, in promoting the renewal of the dielectric in the machining gap and which allows, on the other hand, evacuating from the machining area the degraded dielectric, as well as the residues resulting from the removal of material.

For example, in the case of channel-type openings, the forced circulation of machining liquid in the machining gap may be created by injecting the machining liquid into the channels at their end close to the electrode holder.

The tool-electrode according to a first embodiment is illustrated in FIG. 2; in this case, the tool-electrode 1 is a parallelepipedal block of material in which through-channels 8 are formed each having a diameter “d” smaller than or equal to twice the value of the die-sinking machining gap (i.e. in the blank mode).

As a reminder, in our embodiment, it is desired to make sealing slots with a width of 0.8 mm and a depth of a few millimeters (2 to 5 mm). Hence, to make the tool-electrode, it is possible to use a block of material having a height “H” of about 15 mm and a thickness “e” of 0.4 mm. For the thickness of the tool-electrode, compliance with the formula e<I−2×G is ensured, “I” being the sealing slot width to be obtained. The length “L” of the tool-electrode may be a few millimeters or centimeters.

In this block of material, a multitude of through-channels 8 are formed having, for example, a diameter “d” of 0.3 mm, which are arranged parallel to one another in the die-sinking direction Z (in the height direction) and according to one single row. In this example, the channels are spaced apart from one another by a value “c” equal to twice the machining gap in the blank mode G.

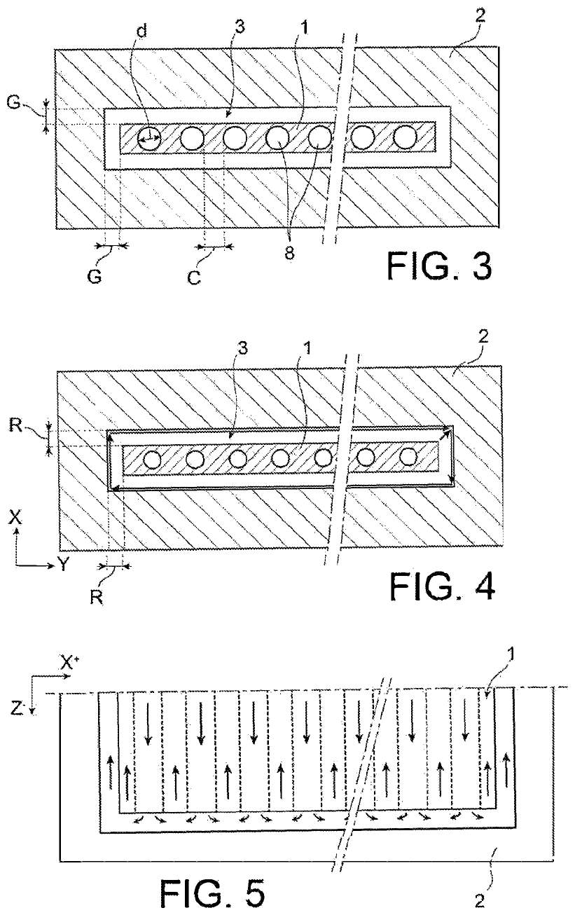

In FIG. 3, there is a sectional view of FIG. 2 according to the plane A, the tool-electrode 1 being shown inside the machining cavity of the part 2 during the blank mode.

In FIG. 4, the tool-electrode is shown inside the machining cavity during the finish mode; the movement of the tool-electrode in the X-Y plane in the finish mode (after die-sinking thereof at the bottom of the machining cavity according to the Z direction) is schematized by arrows in bold lines. R represents the eccentricity radius in the finish mode and is larger than the machining gap in the blank mode G.

The injection of the clean dielectric is done under pressure into the channels 8, for example between 2 and 50 bar. This injection under pressure allows for a sufficient watering by the inside of the tool-electrode and an evacuation by the sides of the latter. FIG. 5 is a sectional view showing the tool-electrode of FIG. 2 in the machining cavity, the large downward black arrows representing the clean dielectric circulating in the channels, the small horizontal black arrows representing the clean dielectric at the outlet of the channels and the large upward white arrows representing the “dirty” dielectric which is evacuated by the sides of the tool-electrode.

It is specified that the channels 8 should not have a diameter larger than twice the machining gap in the blank mode, otherwise there is a risk of generating material core drills inside these in the blank mode (direct die-sinking of the tool-electrode according to a vertical axis Z). Any surface irregularities at the bottom of the machining cavity connected to the injection channels will be levelled out by the planetary movement of the tool-electrode in the finish mode.

The injection channels will allow improving the evacuation of the slags created during die-sinking of the tool-electrode and, consequently, increasing its speed of advance.

In the finish mode, the same machining strategy is used by carrying out a planetary movement in the X and Y directions with an eccentricity radius R larger than or equal to the machining gap in the blank mode G (the finish eccentricity radius is R=0.2 mm in our example). In other words, the electrode is moved, on either side of its central position, by at least 0.2 mm in the X direction, and by at least 0.2 mm in the Y direction to obtain a 0.8 mm wide sealing slot using a 0.4 mm wide tool-electrode. The finish gap is defined at 0.05 mm. At the end of the finish operation, wear of the sidewalls of the electrode is estimated to be 0.05 mm. Thus, the thickness of the used electrode at the end of the finish operation is about 0.3 mm. The finish operation allows ensuring a recovery of the surfaces of the imprint and reducing the roughness of the surfaces obtained in a blank.

Herein again, the planetary movement of the tool-electrode according to the X and Y axes, associated with injection into the tool-electrode, improves the circulation of the dielectric and the rapid evacuation of the debris located at the bottom of the machining cavity. Furthermore, it optimizes and stabilizes sparking by improving the recycling of the dielectric between the tool-electrode and the part to be machined.

According to a second embodiment illustrated in FIG. 6a, the tool-electrode has a comb-like shaped configuration, obtained by forming a series of slots 9 in the bottom portion (i.e. the lower area) of the body of the tool-electrode, the space between two adjacent slots forming one tooth of the comb. Each slot has a width “a” that is smaller than or equal to 2×G and a height “h” that is larger than or equal to 3×P, P being the depth of the sealing slot to be machined. The desired depth “P” amounting to a few millimeters (2 to 5 mm), we have chosen h=10 mm. The spacing width “b” between two adjacent slots (i.e. the width of one tooth) is herein selected to be equal to 2×R. “H” is the total height of the tool-electrode. In our example, the Inventors have chosen H=15 mm to ensure enough contact surface in the electrode holder.

A sectional view according to the line B-B of FIG. 6a is illustrated in FIG. 6b.

This comb-like shaped configuration will, during die-sinking of the latter, enable the formation of spaces between the teeth (i.e. in the slots), which will improve the distribution of the dielectric at the bottom of the cavity (by immersion of the part and by external spraying around the tool-electrode causing a circulation of the machining liquid between the slots).

The width “a” of the slots should not be larger than twice the value of the machining gap in the blank mode G, so as to be able to machine the CMC material located at the level of the slots. With this configuration, there might be surface irregularities in the form of domes created at the bottom of the machining cavity vertically in line with the slots, but these irregularities will be easily eliminated with the movement of the X- and Y-tool-electrode in the finish regime.

A third embodiment is illustrated in FIG. 7a and is a combination of the first and second configurations. Thus, there are channels 8 in the top portion (i.e. the upper area of the body) of the tool-electrode, these channels opening onto slots 9 formed in the bottom portion (i.e. the lower area of the body) of the tool-electrode, as shown in FIG. 7b. The combination of the channels and of the slots allows for a better distribution of the dielectric the closest to the sparking in order to obtain a better machining stability and to optimize the evacuation of slags and therefore to gain in performance.

To make the channel or slit type openings of the above-described different configurations, the Inventors have chosen to machine them in thick plates of the CuCrZr type (AFNOR standard), for example made of CuCr₁Zr_{0.1} alloy. They have selected several machining processes according to the shapes of the openings to be made.

In order to make the 0.3 mm diameter through injection channels over the entire height of the electrode, it is possible to use an EDM rapid drilling by taking water as a machining liquid and tubular electrodes made of brass with an external diameter of 0.25 mm. Another possible alternative is the use of conventional EDM with solid electrodes made of cupro-tungsten, but the cycle time is longer.

To make the slots (and thus form the teeth of the comb), it is possible to use wire EDM cutting with a 0.15 mm diameter wire instead of the 0.25 mm diameter wire used in standard wire EDM. Another possible alternative is the use of a fiber-type cutting laser, whose wavelength is in the near-IR range (≈1,060 nanometers).

In order to obtain the 0.4 mm thickness of the tool-electrode, it is possible to make a blank in EDM wire cutting, and to carry out a recovery of the faces by grinding (finishing) to ensure geometric requirements such as the accuracy of the sides and the flatness of the reference faces.

These electrode shapes may also be made by additive manufacturing or built in 3D per powder bed fused by a laser beam.

The tool-electrode according to the invention with its different possible configurations is relatively easy to obtain by the different above-described machining processes. The manufacturing extra cost after an optimization is largely alleviated by the provision of a significant gain during making of the imprints with reduced cycle times and a better quality obtained.

Preferably, the electrode is made of a CuCrZr type alloy, preferably of CuCr₁Zr_{0.1} which has a better rigidity and resists erosion wear better compared to a Cu-u1 electrode (AFNOR standard (or Cu-ETP (ISO standard)). Yet, other materials could be used like, in particular, all copper-based alloys, graphites, brass, tungsten carbide or cupro-tungsten.

It should be recalled that the tool-electrode according to the invention has been designed to solve a problem of EDM machining of sealing slots in a SiC/SiC ceramic matrix composite material, but it may be used to make other types of imprints by EDM on other types of CMC materials and other electrically-conductive materials, in particular metal materials.

When the tool-electrode includes channels, the distribution of the dielectric in the channels of the tool-electrode takes place under pressure, preferably between 2 and 50 bar; a watering is thus obtained by the inside of the tool-electrode.

For the machining of an imprint (for example a sealing slot) with the tool-electrode having a comb-like shaped configuration, a low-pressure external watering (for example comprised between 0.1 and 2 bar) around the latter is used to promote the circulation of the dielectric between the teeth of the comb.

The improvement in the circulation of the dielectric in the machined shapes using the tool-electrode according to the invention, by the channels inside the tool-electrode and/or by the teeth of the comb, with identical machining parameters, allows evacuating the residues resulting from the erosion more rapidly. The fact of not re-machining on the debris results in an improvement in the speed of advance of the die-sinking and therefore the machining efficiency. The use of the tool-electrode according to the invention in an EDM process allows optimizing the process, and could therefore be applied to an industrial production for parts in series.

These configurations which facilitate the circulation and renewal of the clean dielectric also allow controlling the sparking better and therefore the surface quality in the finish mode, associated with the planetary movement of the tool-electrode.

1. A tool-electrode for machining, in a part made of an electrically-conductive material, an imprint by sinking-die type electrical-discharge machining, the tool-electrode including a body made of an electrically-conductive material having a lower face and an upper face, opposite to each other, and two main lateral faces, opposite to each other, the body having a lower area and an upper area, which are superimposed according to a die-sinking direction (Z) of the tool-electrode, the lower area comprising the lower face and a portion of the main lateral faces and the upper area comprising the upper face and the other portion of the main lateral faces,
wherein the body is provided, at least in the lower area, with a plurality of openings selected from among channels or slots,
a channel being an opening that opens onto at least one amongst the upper and lower faces,
a slot being an opening that opens onto the lower face and onto the two main lateral faces,
each channel having a diameter smaller than or equal to twice the die-sinking machining gap (G), and
each slot having a width, defined by a distance between two lateral walls of the slot, smaller than or equal to twice the die-sinking machining gap (G), and a height, in the die-sinking direction, larger than or equal to three times the depth of the imprint to be made,
wherein the die-sinking machining gap is comprised between 0.02 mm and 0.3 mm.

2. The tool-electrode according to claim 1, including channels in the lower area and which extend in the upper area, each channel opening onto both the lower face and the upper face of the body.

3. The tool-electrode according to claim 2, wherein the distance between two adjacent channels is larger than or equal to twice the die-sinking machining gap.

4. The tool-electrode according to claim 1, including openings only in the lower area, these openings consisting of slots.

5. The tool-electrode according to claim 4, wherein the distance between two adjacent slots is larger than or equal to twice the die-sinking machining gap.

6. The tool-electrode according to claim 1, including slots in the lower area and channels in the upper area, each channel of the upper area opening onto a slot of the lower area.

7. The tool-electrode according to claim 1, wherein the body is made of a CuCrZr copper alloy.

8. The tool-electrode according to claim 1, wherein the imprint to be machined having to have given depth, length, and width, the body of the electrode has a thickness that is smaller than a value corresponding to the width of the imprint, from which the die-sinking machining gap is subtracted twice.

9. A machining device for machining an imprint by die-sinking type electrical-discharge machining, comprising a tool-electrode according to claim 1, and means cooperating with the openings of the tool-electrode to create a machining liquid circulation in the bottom of the imprint being formed, said means being selected from among means for injecting pressurized machining liquid into the plurality of openings of the tool-electrode, when the openings are channels, and means for injecting machining liquid around the electrode, when the openings are slots.

10. A method for forming an imprint in a part made of an electrically-conductive material by electrical-discharge machining, implementing a machining device according to claim 9, and comprising the steps of:
immersing the part in a machining liquid;
forming a blank of the imprint, by die-sinking the tool-electrode according to the die-sinking direction and concomitant injection of machining liquid into the plurality of openings of the tool-electrode to create a machining liquid circulation in the bottom of the blank;
finishing the imprint by placing the tool-electrode at the center of the blank and off-centering the tool-electrode in a plane perpendicular to the die-sinking direction, wherein the eccentricity radius is larger than or equal to the die-sinking machining gap.

11. The method according to claim 10, wherein the imprint to be machined is a sealing slot and the part is made of SiC/SiC composite material.
